(19) United States
(12) Patent Application Publication
(10) Pub. No.: US 2011/0202922 A1
(43) Pub. Date: Aug. 18, 2011

(54) SYSTEM RESOURCE INFLUENCED STAGED SHUTDOWN

(75) Inventors: Matthew Stephen Reynolds, London (GB); Toby Gray, London (GB); Carlos Freitas, London (GB)

(73) Assignee: NOKIA CORPORATION, Espoo (FI)

(21) Appl. No.: 12/811,326

(22) PCT Filed: Dec. 22, 2008
(86) PCT No.: PCT/GB2008/004263

§ 371 Date: Feb. 23, 2011

(30) Foreign Application Priority Data
Dec. 31, 2007 (GB) 0725378.4
May 30, 2008 (GB) 0809928.5

(51) Int. Cl. G06F 9/46

(52) U.S. Cl. 718/100

(57) ABSTRACT

The present invention provides a method for shutting down a computing device on which multiple software components are running. More specifically, the present invention provides a method for prioritising the shutdown of the software components according to whether the device will experience significant problems when restarting if the components are not provisioned sufficient resources to complete specific shutdown operations.

### TECHNICAL FIELD

The present invention relates to a computing device and an associated method of shutting down such a device. More specifically, when shutdown of the device is requested, a multiplicity of software components are running on the device and each component is instructed to perform shutdown tasks in a sequence according to how severely the computing device is affected if the component is unable to complete its shutdown tasks.

### BACKGROUND OF THE INVENTION

It is known that when a computing device such as a mobile communications device is operating, an operating system of the device initiates and controls execution of various software components. The operating system executes each component to perform some aspect of computation that contributes to a main operational function of the mobile communications device, such as, for example, hosting a telephone call or receiving a message. In practice, to perform main operational functions, known computing devices perform a number of smaller operations that combine to enable the main operation. Each smaller operation may be performed by a single component or multiple components depending on the component type and the operation.

In the exemplary case of hosting a telephone call using a mobile communications device, smaller operations might be: receiving a telephone number from a user of the mobile communications device, establishing communications with a cooperating mobile telecommunications network, encoding speech from the user, or decoding speech for the user.

In order to organise the many software components running on a computing device at any given time, the computing device arranges them into a layered structure. Each layer corresponds to a level of abstraction from a base operation level. As such, components of the lowest layer implement basic, primitive functions that execute very quickly. The lowest layer is also the most privileged layer, so components within that layer are generally able to access all elements of the operating system. Moving through the layered structure from the lowest layer to the highest layer, the functions executed by components within each layer get less primitive and privileges are taken away. It is also often the case that the operations of components within higher layers are dependent upon the operations of components within lower layers.

It is known that for a component to operate, it requires at least one of the following limited resources: power, storage capacity and memory. When a request to shut down the computing device is received, whether initiated by the device or by a user of the device, the device must handle all the components running on the device at that time. In order to handle the running components the device must schedule access to the limited resources so that the components may finish their operations. Operations that may typically require to be completed by a component before the component shuts down include saving data from working memory into storage memory, flushing caches, or setting regions of persistent memory to be read-only. Such tasks are referred to herein as shutdown tasks.

It is the case that for some components there are no significant consequences to removing power while the component is in the middle of its operation. However, for some other components, removing power while the component is in the middle of its operation is likely to cause a significant problem when the device restarts, and could lead to the device malfunctioning, only partially functioning or not functioning at all. One possible event which could create a significant problem is the corruption or loss of data critical to the running of the device. Such events can cause problems on re-start, for example by requiring data integrity routines to be run on re-start, thus delaying re-start. In extreme cases, data can be lost.

A complication in the abovementioned shutdown procedure is that components usually require the use of storage capacity and memory when completing operations, and these resources, like power, are also in limited supply. Often the shutdown will be caused in the first place by a lack of such resource—typically when the device's battery has run out.

It is known in the field of personal computers to assign a shutdown priority level to a process running on a personal computer. These shutdown priority levels define a shutdown order for processes relative to other processes in a system. An example case is the Microsoft® Windows® function ‘SetProcessShutdownParameters’ that is featured in the Microsoft Developers Network (MSDN®). It is noted that these known systems simply enable the specification of an order in which processes are shutdown and they do not define any particular order.

It is also known in both the fields of personal computers and mobile communications devices to implement priority strategies in order to schedule processes running in a system. In a priority strategy, processes have a priority level which corresponds to how important the function of that process is to the system. In priority strategies, the process allowed to run is the process waiting which has the highest priority. Priorities usually take the form of a number, although, there is no general agreement between systems on assigning priorities to processes. Generally, the higher the priority the more important the process is, and therefore, the process with the lowest priority does the most menial of tasks. It should be noted that priority strategies are used by a system to schedule the operation of processes in order to make the system operate efficiently. Priority strategies do not schedule processes to preserve the integrity of a system and do not thereby avoid significant problems when the system restarts following a shutdown.

### SUMMARY OF THE INVENTION

In order to address the above problems, an embodiment of the present invention provides a method for shutting down a computing device on which multiple software components are running. More specifically, an embodiment of the present invention provides a method for prioritising the shutdown of the software components according to whether the device will experience significant problems when restarting if the components are not provisioned with sufficient resources to complete specific shutdown operations.

In view of the above, the present invention provides a method of shutting down a computing device having a plurality of software components running on the device, the method comprising:

a. assigning to at least one component a shutdown classification according to how critically the computing device is affected if the or each component is unable to complete its shutdown tasks;
b. detecting a shutdown request; and
c. notifying each component in a sequence according to the shutdown classifications to perform its shutdown tasks;

wherein each notified component performs its shutdown tasks in response to the shutdown notification.

It is a further aspect of the present invention to provide a computing device comprising a shutdown manager, wherein a plurality of software components are running on the device, and the shutdown manager performs the following steps:

a. assigning to at least one component a shutdown classification according to how critically the computing device is affected if the or each component is unable to complete its shutdown tasks;
b. detecting a shutdown request; and
c. notifying each component in a sequence according to the shutdown classifications to perform its shutdown tasks;

wherein each notified component performs its shutdown tasks in response to the shutdown notification.

It is a primary purpose of the present invention to schedule the shutdown of components which perform operations that are critical to the integrity of the computing device before components which perform non-critical operations. Accordingly, it is a primary advantage of the present invention that the risk of losing or corrupting data which is critical to the running of the device is minimised. Therefore, the present invention reduces the probability that the computing device malfunctions, only partially functions or does not function at all, or that data is lost.

It is another advantage of the present invention that non-critical components are not scheduled to use up the limited resources of the computing device that would be better assigned to more critical components. A further effect of the present invention is that because fewer critical components are unable to complete their shutdown tasks before power is removed, fewer data integrity checks need to be performed when the device starts up, to repair lost or corrupt data. Therefore, it is a further advantage of the present invention to enable faster restarting times due to a reduced need to perform data integrity checks.

Preferably, a shutdown classification is assigned to each component that has at least one specific task to perform at device shutdown.

Preferably, the sequence in which an embodiment notifies running components to perform their shutdown tasks starts with the component having the most critical shutdown classification and then continues in an order of reducing criticality until the component having the least critical shutdown classification is notified.

Preferably, the sequence takes into account each component's dependencies with other components. Therefore, when each component is notified to perform its shutdown tasks, interdependent components of that component are also notified to perform their shutdown tasks before the next component in the sequence is notified to perform its shutdown tasks.

Preferably, the sequence corresponds to a layered structure of an operating system of the computing device. Therefore, components initiated by a lower layer are only notified to perform their shutdown tasks once all components initiated by higher layers have been notified to perform their shutdown tasks.

Preferably, two shutdown classifications are defined; ‘critical’ and ‘non-critical’.

Preferably, the limited resources include: battery power, storage capacity and memory.

Preferably, power to the computing device is removed after all notified software components have performed their shutdown tasks.

Preferably, the computing device is a mobile communications device. The application of the invention to a mobile communications device, such as, for example, a mobile telephone provides particular advantages as such devices are often extremely resource limited.

### BRIEF DESCRIPTION OF THE DRAWINGS:

A description of a preferred embodiment of the present invention, presented by way of example only, will now be made with reference to the accompanying drawings, wherein like reference numerals refer to like parts, and wherein:

FIG. 1 is a schematic view of a known mobile communications device;

FIG. 2 is a schematic view of the internal hardware elements of the known mobile communications device;

FIG. 3 is a schematic view of the software content stored on an internal hardware element of the known mobile communications device;

FIG. 4 is a schematic view of an exemplary structure of the software content of FIG. 3;

FIG. 5 is a schematic view of interdependent software processes running on the known mobile communications device;

FIG. 6 is a schematic view of interdependent software threads running within a software process of FIG. 5;

FIG. 7 is a schematic view of the software content stored on an internal hardware element of a mobile communications device arranged according to a preferred embodiment of the present invention; and

FIG. 8 is a flow diagram illustrating the operation of the mobile communications device arranged according to the preferred embodiment.

### DESCRIPTION OF EMBODIMENTS

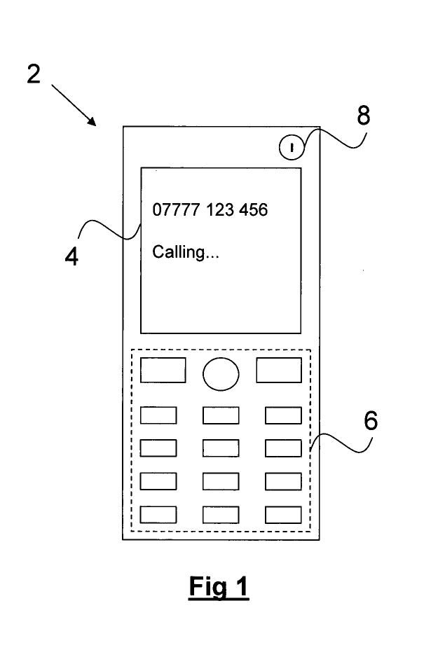

Embodiments of the invention are based on a known mobile device platform, described next with respect to FIGS. 1 to 6.

A known mobile communications device is represented in FIG. 1 by reference numeral 2. The mobile communications device 2 comprises a display screen 4, input buttons 6 and a power button 8. The mobile communications device 2 is capable of being operated by a user to perform a variety of operations, such as, for example, hosting a telephone call.

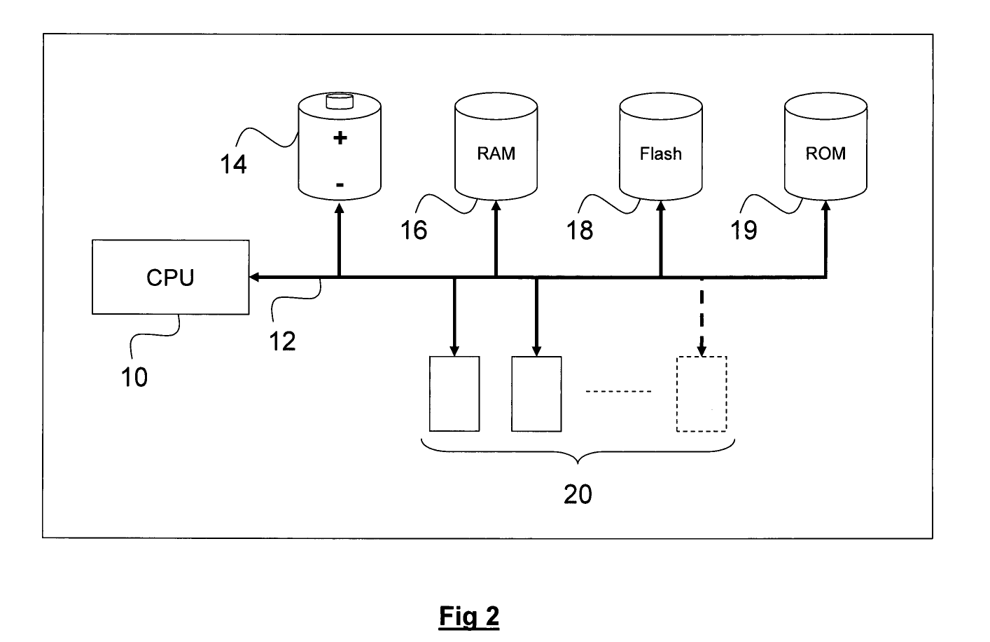

FIG. 2 shows a schematic view of some of the internal hardware elements of the mobile communications device 2. A central processing unit (CPU) 10 is connected to a hardware bus 12 which in-turn is connected to a variety of hardware units including: a battery 14, some random access memory (RAM) 16, long term storage such as flash memory 18, some read-only memory (ROM) 19 and multiple hardware devices 20. Hardware devices 20 comprise devices, such as, for example, the input buttons 6 and the display screen 4. Although hardware devices 20 are required for the mobile communications device 2 to function, they do not specifically form part of the present invention and, therefore, will not be discussed in detail.

In operation, the hardware bus 12 provides a communications link between the hardware units 16 to 20 and the controlling CPU 10. Control commands are issued to the hardware units 16 to 20 by the CPU 10, and data is returned by the hardware units 16 to 20 in the opposite direction. The battery 14 provides power for the arrangement. Additionally, the

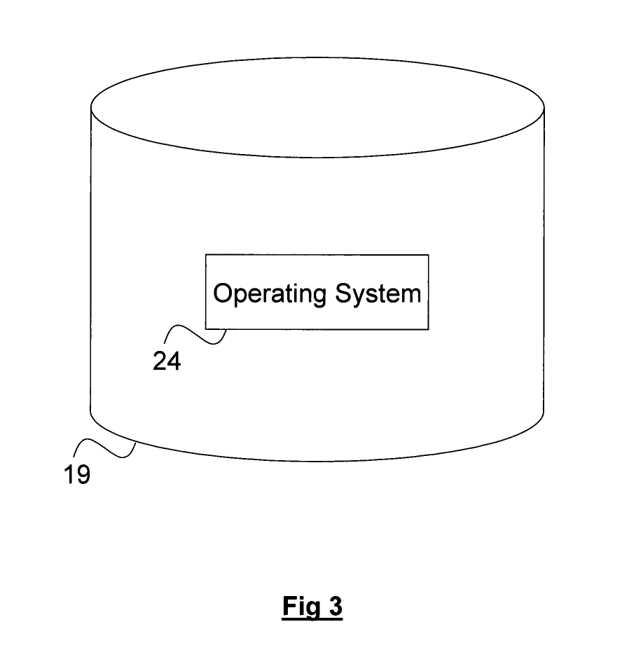

CPU 10 processes the data received from the hardware devices 16 to 20 in order to complete its operational tasks. Therefore, the CPU 10 instructs and controls the hardware devices 16 to 20 to provide the functionality of the mobile communications device 2. The operation of the CPU 10 is dictated by a software operating system 24 which, as shown more particularly in FIG. 3, is typically stored on the ROM 19. Generally speaking it is the role of the operating system 24 to manage hardware and software resources of the computing device. These resources include such things as the CPU 10, the RAM 16, and the memory 18. As such, the operating system provides a stable, consistent way for software applications running on the device 2 to deal with the hardware resources of the device 2 without the application needing to know all the details of the physical resources available to the hardware.

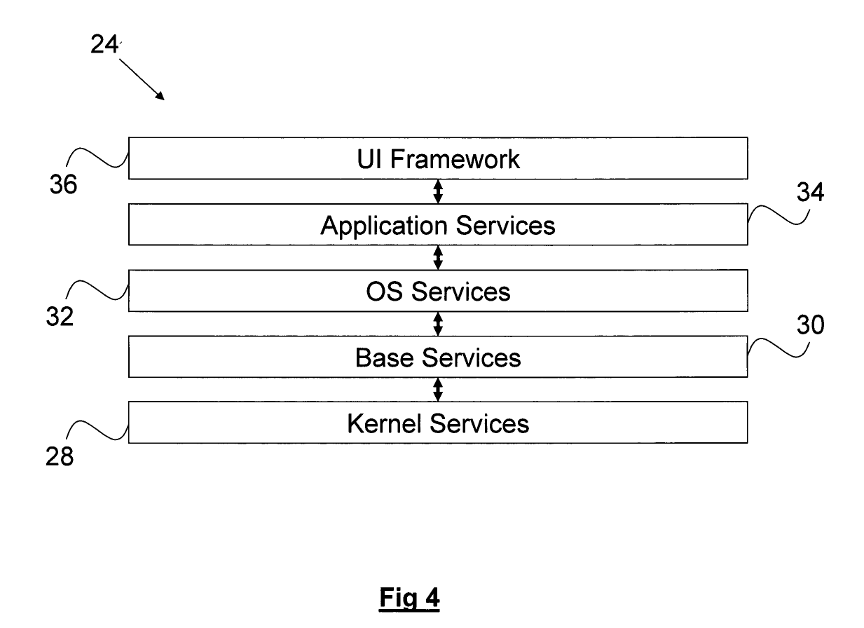

FIG. 4 illustrates an exemplary structure of the operating system 24 installed on the mobile communications device 2. The operating system 24 comprises a number of layers: a kernel services layer 28, a base services layer 30, an operating system (OS) services layer 32, an application services layer 34 and a user interface framework layer 36. The layers 28, 30, 32, 34 and 36 reflect the functionality at different levels within the operating system 24. Multiple software components, such as processes and threads, operate within the structure of operating system 24 to enable the mobile communications device 2 to function. Generally speaking, layers that are further away from the bottom kernel services layer 28 know less of the details of the physical resources available to the hardware.

Kernel services layer 28 is the lowest layer and implements the most basic primitive functions that execute very quickly. Additionally, layer 28 is the most privileged layer and is able to access all elements of the operating system 24. If each outer layer 30, 32, 34 and 36 is considered in order, the functions of the layers 30, 32, 34 and 36 become less primitive and privileges are taken away the further each layer 30, 32, 34 and 36 is positioned from the layer 28.

The base services layer 30 provides frameworks, libraries and utilities that enable the hardware devices 14 to 20 in combination with the CPU 10 to be turned into a programmable machine. The OS services layer 32 controls the layers beneath (28, 30) to provide a fully functional operating system that is capable of providing services across a range of different technologies, such as, for example, telephony, messaging, graphics and data connectivity. The application services layer 34 provides a generic framework for software applications and services specific to different technologies available. Finally, the user-interface framework layer 36 provides a framework of services for user-interface platforms, including, for example, a graphical user-interface framework.

In each layer 28, 30, 32, 34 and 36 of the operating system 24, the operations of that layer are implemented by the mobile communications device 2 using a variety of different software components, such as, for example, processes and threads. Each operation may be performed by a single component or multiple components depending on the component type and the operation.

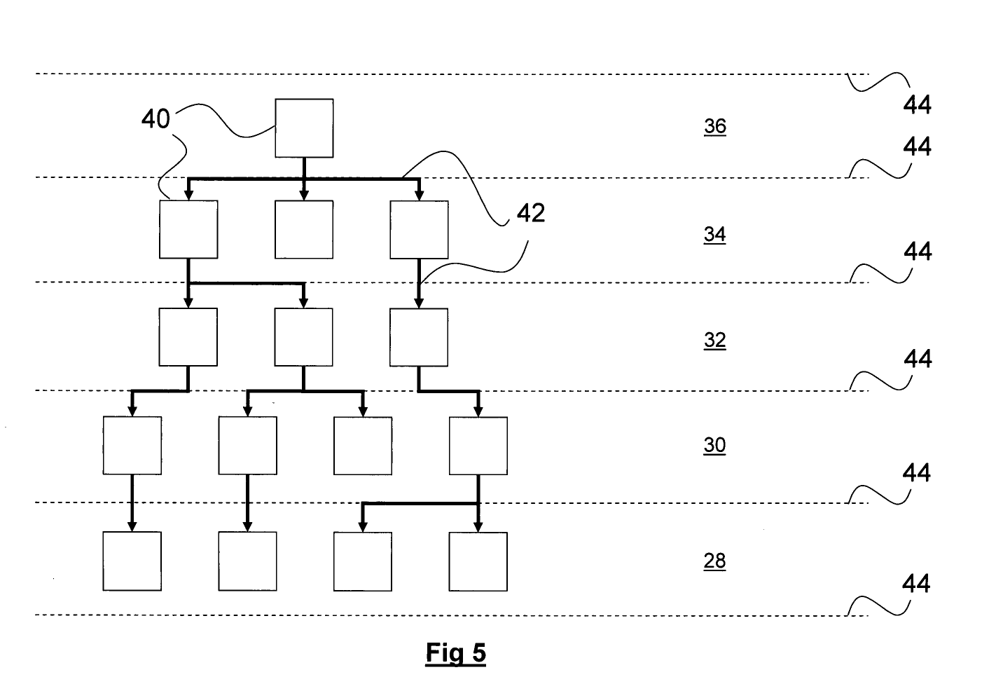

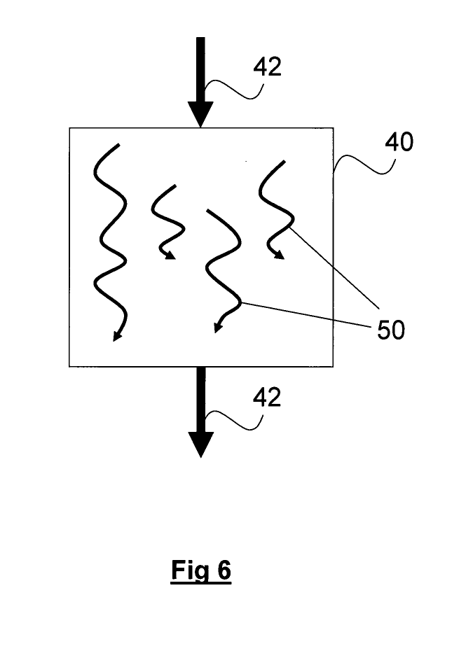

FIGS. 5 and 6 illustrate how the operating system 24 initiates multiple software components on the mobile communications device 2 to execute the functionality of the mobile communications device 2. FIG. 5 shows multiple processes 40 which are connected together by links 42. The arrows of the links 42 indicate the operational flow between the processes 40 and, therefore, processes occurring at the top of FIG. 5 are performed and completed before processes lower down. Dotted lines 44 represent boundaries between the layers 28, 30, 32, 34 and 36 of the operating system 24 and, therefore, lines 44 can be used to determine which layer 28, 30, 32, 34 or 36 instantiates each process 40.

The exemplary case of FIG. 5 shows that a single process 40 is instantiated in the user-interface framework layer 36, for example, as a result of a user of the mobile communications device 2 instructing the mobile communications device 2 to shutdown by pressing the power button 8. FIG. 5 also illustrates that as the operating system 24 of the mobile communications device 2 performs the shutdown operation as instructed, multiple other processes 40 are initiated to complete smaller operations which combine together to enable the overall shutdown operation. The links 42 indicate dependencies which exist between the processes 40.

FIG. 6 shows one of the processes 40 of FIG. 5 in detail to illustrate that some processes 40 contain multiple smaller software components, or threads 50. Each thread 50 may perform a smaller sized operation than the operation performed by the process 40. Additionally, the operation performed by the thread 50 contributes to performance of the larger operation of the process 40 that the thread 50 is located within. Alternatively, the threads may be used to allow multiple instances of the operation to operate at the same time, on the same data. The passage of time is represented by the arrows of the threads 50 and the links 42 and, therefore, operations occurring higher up FIG. 6 occur before operations occurring lower down FIG. 6.

One of the ways in which the operating system 24, as defined above, manages the hardware and software resources of the mobile communications device 2 to ensure that the mobile communications device 2 operates stably is through the use of a System State Manager (SSM) (not shown). It is the role of the SSM to manage the state of the mobile communications device 2 throughout its lifecycle, including, start-up and shutdown. The SSM provides an interface that allows a software component running on the mobile communications device 2 with appropriate security privileges to request a change of the system state. There are four different states in which the mobile communications device 2 may function; they are: start-up, shutdown, normal and fail. The SSM is configured so that the occurrence of different events causes the SSM to change the state of the mobile communications device 2. For example, the SSM moves the mobile communications device 2 into a fail state if there have been consecutive start-up failures.

System states are defined by policies that are implemented in software code located on Flash 18 or ROM 19. The policies define the four above-mentioned states, permissible state transitions and tasks that are performed during state transitions. In the event that the mobile communications device 2 changes state the SSM distributes system state change notifications to software components which have requested to be notified. Then, notified processes are able to temporarily delay a pending state change in order to perform necessary tasks that must be performed before the state changes. Additionally, the system state policies define a maximum response time in which the notified components must complete their tasks and what happens when the notified components do not complete their tasks within that time.

Thus far, the above description of the mobile communications device 2 and its operation comprises matter included in the state of the art. Next we describe the additions provided in the present embodiment to address the problems noted earlier.

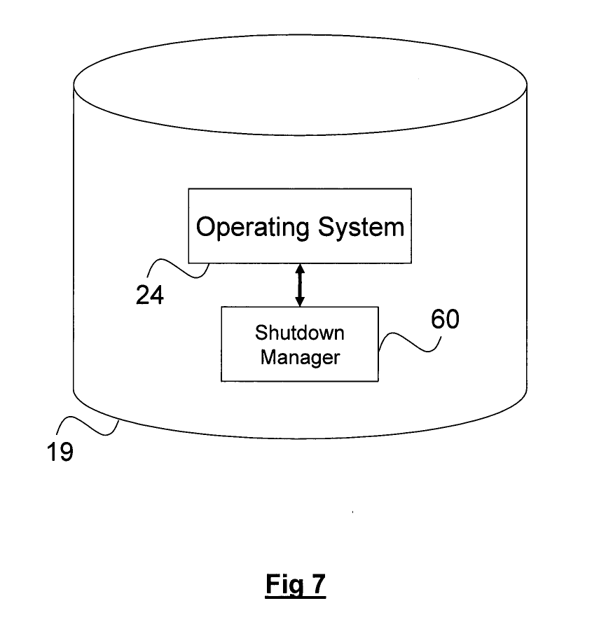

More particularly, a preferred embodiment of the present invention provides the mobile communications device 2 comprising the operating system 24 as herein-before described with reference to FIGS. 1 to 6. However, as seen more particularly in FIG. 7, the ROM 19 of the preferred embodiment further comprises a shutdown manager 60 that is able to influence the operation of the operating system 24. The operation of the shutdown manager 60 is closely linked with the SSM and in some embodiments the shutdown manager 60 forms a part of the SSM that handles system shutdowns.

Shutdown classifications are assigned to every software component that has at least one specific operation to perform after a device shutdown has been detected and before the device shutdown is completed. A number of different methods may be used to indicate and assign shutdown classifications of software components. In one implementation the classifications are indicated by process metadata and are manually assigned by a developer when the computer code defining a software component is created.

Alternatively, in another implementation, classifications are stored in a flash memory text file (not shown) that is stored on the flash memory 18. The contents of the text file comprise a list of software components, referenced by name, and for each software component, a corresponding shutdown classification. Each software component mentioned in the text file is a software component of the operating system 24 and, therefore, performs a task which contributes to the functionality of the operating system 24. Additionally, each software component mentioned in the text file has specific tasks to perform after a device shutdown is detected and before the device shutdown finishes. At compile time each software component featured in the text file is assigned a shutdown classification according to its respective entry in the text file.

Regardless of which implementation is used to indicate and assign shutdown classifications, software components that do not have specific shutdown tasks to perform are not assigned a shutdown classification. Conversely, software components that do have specific shutdown tasks to perform are assigned an appropriate shutdown classification of either ‘critical’ or ‘non-critical’.

A critical classification is assigned to software components of the operating system 24 that are considered to critically affect the integrity of the mobile communications device 2 if they are not provided with sufficient resources to complete their shutdown tasks. An example of a critical effect is the loss or corruption of data that causes the mobile communications device 2 to malfunction when restarted following a shutdown. A non-critical classification is assigned to software components of the operating system 24 that do not critically affect the integrity of the mobile communications device 2 if those components are not provided with sufficient resources to complete their shutdown tasks. Software components of the operating system 24 with critical classifications are herein-after referred to as critical components, whereas software components of the operating system 24 with non-critical classifications are herein-after referred to as non-critical components.

Some examples of critical components that may run on a computing device include:
file system processes that flush caches;
persisting changeable settings, for example, modifiable hardware abstraction layer attributes, or flushing database caches;
initialisation of applications that are installed on devices after the devices have been sold to consumers.

Some examples of non-critical components that may run on a computing device include:
session initiation protocol (SIP) server processes (where the network registration will simply time-out);
universal plug and play (UPnP) network service processes (where service indications will simply time-out);
non-system applications (such as a game where it may be desirable to save a user's highest score).

Typically, non-critical components reside in higher layers of the operating system 24 while critical components reside in lower layers, although this need not always be the case.

In operation, when a device shutdown is requested the shutdown manager 60 issues state change notifications to announce a change in the system state of the mobile communications device 2 to software components that have shutdown tasks to perform. For example, a device shutdown request may occur as a result of the mobile communications device itself requesting shutdown because its battery power has become too low to sustain continued operation.

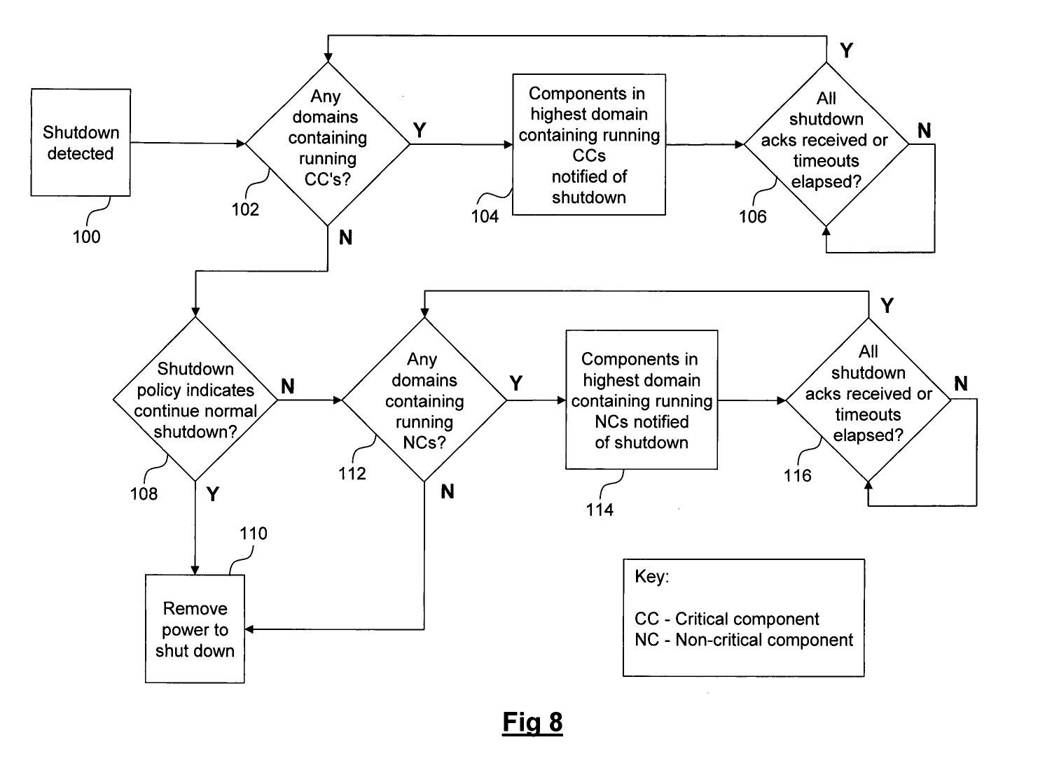

Operation of the shutdown manager 60 from such time that a device shutdown is detected will now be described with reference to the flow diagram of FIG. 8. Step 100 indicates that the SSM detects a device shutdown. Once the SSM has detected a shutdown, the SSM, operating as a shutdown manager 60, notifies running software components to perform shutdown tasks according to which layer (28 to 36) of the operating system 24 initiated them. More specifically, all running software components are organised into a hierarchy of domains that are maintained by a domain manager (not shown). The domain manager is an internal element of the shutdown manager 60 and the structure of the domain hierarchy corresponds to the layered structure of the operating system 24. The contents of each domain are arranged to contain a group of software components that all initiated from a similar position in the layered structure of operating system 24. As such, when a software component is assigned a shutdown classification the component registers into a domain which corresponds to the position in the operating system's layered structure from which the component initiated.

Additionally, it is frequently the case that the operation of a software component may be dependent on another software component's operation. Domains are defined such that within a single domain, no software components may be dependent upon any other software components also within that same domain. Therefore, when software components that originate from a similar position in the layered structure of the operating system 42 are interdependent upon each other, multiple domains are created that all correspond to the same position in the layered hierarchy of the operating system 24.

Once the SSM has detected a shutdown in step 100 processing flows to step 102 wherein the shutdown manager 60 notifies all software components in the highest domain having running critical components of the pending shutdown. After notification, processing flows to step 104. This operation of the SSM effectively notifies components of a change of system state to a new critical-shutdown system state. Step 104 indicates that only critical components within that highest domain react to the notification by performing their shutdown tasks. It is noted that although software components in that domain which are not critical also receive the notification of the shutdown, only the critical components react to the notification. Following this operation processing flows to step 106. Having received notification to perform shutdown tasks, the critical components perform those tasks and acknowledge to the SSM when they have completed them. Processing waits at step 106 until all the notified critical components in the highest domain have acknowledged to the SSM that they have completed their tasks, at which time processing flows back to step 102. Additionally, processing will flow from step 106 to step 102 if all the notified critical components in the highest domain have not acknowledged but a predefined timeout period has expired. Once back to step 102 the SSM notifies all the components in the next highest domain having running critical components of the pending shutdown. Processing will then flow from step 102 to steps 104 and 106 and then back to step 102, as discussed above with reference to the highest domain but this time with reference to the next highest domain.

Processing from step 102 will continue to flow around in a loop back to step 102 via steps 104 and 106 so long as there are domains containing running critical components, there is available power resource and all predefined timeout periods have not expired. The order in which each domain is handled corresponds to the layered structure of the operating system 24. Therefore, critical components in the domain corresponding to the highest layer, layer 36, will be instructed to perform shutdown tasks first. Following that, any remaining critical components will be instructed to perform shutdown tasks in an order according to how far down the layered structure of the operating system 24 their respective domain lies. As such, components of domains corresponding to lower layers are only instructed to perform shutdown tasks after components of domains corresponding to all higher layers have finished performing their shutdown tasks. Moreover, by adhering to this sequence dependencies between software components are handled in an appropriate order. More specifically, software components in higher layers perform higher level operations and are often dependent on software components in lower layers that perform lower level operations. Therefore, by notifying software components in higher layers to perform shutdown tasks before software components in lower layers, software components are shut down in an order according to downward dependencies. Once all critical components have finished performing their shutdown tasks or all timeout periods have expired, processing flows to step 108.

Processing from step 108 will depend on the shutdown policy of the shutdown manager 60 and the status of the limited resources of the mobile communications device 2. In cases where the limited resources are near exhaustion, non-critical components are not instructed to perform their shutdown tasks and power to the device 2 is removed. Such an operation is indicated by a process flow from step 108 to step 110. Alternatively, if none of the limited resources are near exhaustion processing flows from step 108 to 112.

Processing from step 112 is analogous to processing from step 102 with the exception that now ‘non-critical’ components react to a notification of the pending shutdown issued by the SSM. Therefore, this second notification of the SSM effectively notifies components of a change of system state to a new non-critical-shutdown system state. As such, processing will flow in a loop from step 112 to step 114, then to step 116 and then back to step 112 as long as there are domains present containing at least one running non-critical component, and there is available power resource. Alternatively, some non-critical components may remain in a state of performing their shutdown tasks in the event that they have already taken longer than the predefined timeout period to complete those tasks. Once all non-critical components have been instructed to perform shutdown tasks and have acknowledged that they have completed those tasks or all predefined timeout periods have expired, processing flows from step 112 to step 110. As mentioned above, at step 110 power to the mobile communications device 2 is removed which marks the end of the shutdown procedure.

The principle behind the shutdown manager 60 operating as discussed above with reference to FIG. 8 is to implement a shutdown policy whereby, firstly, critical components are shutdown in order of most importance and in an order according to their interdependencies with other components thereby helping to preserve the integrity of the mobile communications device 2. Secondly, the shutdown policy notifies non-critical components to perform their shutdown tasks after all critical components have been instructed to perform their shutdown tasks. This process ensures that limited system resources of the device 2 are not used up by non-critical components when they would be better used by critical components. In this respect, it should be recalled that typically a device shutdown would be commanded by the device itself when one of the limited resources (typically power) is low. What remaining resource there is should therefore be expended on critical components. It is noted that the shutdown policy will only be implemented as long as there is sufficient available resource, such as battery power. If available power resource becomes exhausted during execution of the shutdown policy, power to the mobile communications device 2 will be removed. It is a further advantage of the present invention that a single software component, critical or non-critical, is not able to dominate system resources during a shutdown. This is because the predefined timeout period ensures that after a predefined time period the SSM starts to notify other components of the pending shutdown even if a notified component has not acknowledged that it has completed its shutdown tasks.

The shutdown manager 60 of the present invention has been discussed above with reference to a device shutdown requested by the mobile communications device 2 because, for example, power resource is soon to expire. However, the present invention is also capable of operating when device shutdown is requested by a user of the mobile communications device, for example, when a user presses the power button 8 while the device 2 is switched on. It is noted that most benefit is derived from the present invention when it is used in conjunction with a device shutdown that was requested by the device 2. This is because when a user requests a device shutdown, it is usually the case that there is sufficient power resource for all components to shut down completely. Therefore, there is less need to prioritise the order in which components shut down. That said there is no disadvantage in applying the shutdown policy according to the present invention in such circumstances.

The preferred embodiment of the present invention has been discussed with reference to software components initiated to perform operations of an operating system. However, modifications may be made to the preferred embodiment to create alternative embodiments wherein software components initiated to perform operations of application programs may additionally be subject to a staged shutdown policy. As the purpose of the present invention is to preserve the integrity of a computing device such as a mobile communications device, in one alternative embodiment application program software components may only be assigned a non-critical status. This way, operating system software components preserve an ability to utilise limited system resources before any application program software components by being assigned a critical status.

Although the preferred embodiment has been described with reference to a mobile communications device, the mobile communications device merely provides a vehicle to aid in the explanation of the wider inventive concept taught by the appended claims. Therefore, alternative embodiments that also fall within the scope of the appended claims could operate in combination with other computing devices, such as, for example, a laptop computer or a desktop computer.

Various additions and modifications may be made to the above described embodiment to provide further embodiments, apparent to the intended reader being a person skilled in the art, any and all of which are intended to fall within the scope of the appended claims.

1-26. (canceled)

27. A method comprising:
for at least one of a plurality of software components running on a computing device, assigning a shutdown classification to the at least one component according to how the computing device is affected if the at least one component is unable to complete its shutdown tasks;
detecting a shutdown request for the computing device; and
notifying the at least one component in a sequence according to the shutdown classifications to perform its shutdown tasks;
wherein the at least one notified component performs its shutdown tasks in response to the shutdown notification.

28. A method as claimed in claim 27, wherein a shutdown classification is assigned to at least one component that has specific tasks to perform at device shutdown.

29. A method as claimed in claim 27, wherein the sequence starts by notifying components with the most critical shutdown classification to perform their shutdown tasks and then continues to notify other components in order of reducing shutdown classification criticality to perform their shutdown tasks.

30. A method as claimed in claim 27, comprising:
notifying the at least one component in a sequence according to the shutdown classifications and their dependencies with other components to perform its shutdown tasks.

31. A method as claimed in claim 30, comprising:
notifying the at least one component in a sequence according to a layered structure of an operating system of the computing device to perform its shutdown tasks.

32. A method as claimed in claim 27, further comprising defining two shutdown classifications.

33. A method as claimed in claim 27, wherein shutdown is detected in response to receiving a request for shutdown from a user of the computing device.

34. A method as claimed in claim 27, wherein shutdown is detected in response to: a determination by the computing device that at least one of a number of limited resources available to the device are about to be completely used, and a subsequent request for shutdown.

35. A method as claimed in claim 34, wherein the limited resources include: battery power, storage capacity and memory.

36. A method as claimed in claim 27 further comprising removing power from the computing device after all notified components have performed their shutdown tasks.

37. A method as claimed in claim 27, wherein the computing device is a mobile communications device.

38. A computing device comprising a shutdown manager, wherein a plurality of software components are running on the device, and wherein the shutdown manager :
assigns to at least one component a shutdown classification according to how the computing device is affected if the at least one component is unable to complete its shutdown tasks;
detects a shutdown request of the computing device; and
notifies the at least one component in a sequence according to the shutdown classifications to perform its shutdown tasks;
wherein the at least one notified component performs its shutdown tasks in response to the shutdown notification.

39. A device according to claim 38, wherein a shutdown classification is assigned to at least one component that has specific tasks to perform at device shutdown.

40. A device according to claim 38, wherein the sequence starts by notifying components with the most critical shutdown classification to perform their shutdown tasks and then continues to notify other components in order of reducing shutdown classification criticality to perform their shutdown tasks.

41. A device according to claim 38, wherein the shutdown manager notifies the at least one component in a sequence according to the shutdown classifications and their dependencies with other components to perform its shutdown tasks.

42. A device according to claim 41, wherein the shutdown manager notifies the at least one component in a sequence according to a layered structure of an operating system of the computing device to perform its shutdown tasks.

43. A device according to claim 38, wherein shutdown is detected in response to: a determination by the computing device that at least one of a number of limited resources available to the device are about to be exhausted, and a subsequent request for shutdown.

44. A device as claimed in claim 38 configured to remove power from the computing device after all notified components have performed their shutdown tasks.

45. A device as claimed in claim 38 comprising at least one processor and at least one memory, wherein the at least one memory includes the shutdown manager.

46. A storage medium storing a program or a suite of programs comprising:
a. code for assigning a shutdown classification to at least one of a plurality of software components running on a computing device according to how the computing device is affected if the at least one component is unable to complete its shutdown tasks;
b. code for detecting a shutdown request for the computing device; and
c. code for notifying the at least one component in a sequence according to the shutdown classifications to perform its shutdown tasks.
